(19) United States
(12) Patent Application Publication
(10) Pub. No.: US 2008/0017611 A1
(43) Pub. Date: Jan. 24, 2008

(54) ETCHING APPARATUS AND METHOD

(76) Inventors: Ho-Geun Choi, Suwon-si (KR); Yong-Woo Kim, Hwaseong-si (KR)

Correspondence Address: F. CHAU & ASSOCIATES, LLC, 130 WOODBURY ROAD, WOODBURY, NY, 11797, US

(21) Appl. No.: 11/696,952

(22) Filed: Apr. 5, 2007

(30) Foreign Application Priority Data
Jul. 24, 2006 (KR) 10-2006-69350

(51) Int. Cl. B44C 1/22; C03C 15/00; C23F 1/00

(52) U.S. Cl. 216/53; 156/345.23; 216/83; 216/92; 156/345.2

(57) ABSTRACT

An etching apparatus and an etching method, wherein pressure exerted on a substrate is minimized, and an entire surface of the substrate is uniformly pressed during an etching process. The breakage of the substrate is prevented, and the substrate is uniformly etched. Accordingly, the thickness of the substrate may be reduced.

### CROSS-REFERENCE TO RELATED APPLICATION

This application claims priority to Korean Patent Application No. 2006-69350 filed on Jul. 24, 2006, the contents of which are herein incorporated by reference in their entirety.

### BACKGROUND OF THE INVENTION

1. Technical Field

The present invention relates to an etching apparatus and, more particularly, to an etching apparatus and an etching method etching a target such that the target has a reduced thickness.

2. Discussion of the Related Art

Technologies to reduce the thickness and the weight of a liquid display panel have been developed. A method of reducing the thickness of the liquid display panel includes etching a substrate for the liquid display panel such that the thickness of the liquid crystal panel is minimized.

The substrate has been etched using a dipping method in which the substrate is dipped into etching solution and a spray method in which etching solution is sprayed onto the surface of the substrate.

According to the dipping method, an etching bath is filled with etching solution, and then the substrate is dipped in the etching solution for a predetermined period to etch the substrate. An air tube and a bubble plate are provided in the etching bath in order to reduce etching time by generating bubbles. In such a dipping method, if the bubbles are not uniformly provided on the substrate, the substrate is irregularly etched. However controlling the amount and size of the bubbles is difficult.

According to the spray method, etching solution is sprayed onto the substrate by a nozzle unit to etch the substrate. In such a spray method, since the etching solution is sprayed from a nozzle, the substrate can be broken due to the spray pressure of the nozzle. In other words, if the has the thickness that does not endure the spray pressure of the nozzle through the etching process, the substrate is broken.

### SUMMARY OF THE INVENTION

Embodiments of the present invention provide an etching apparatus capable of etching a target with a uniform thickness such that a yield of a product can be improved, and a method of etching a target by using the etching apparatus.

An etching apparatus, according to an embodiment of the present invention includes an etching rail and a solution supplier.

The etching rail has a space enabling at least one target to move therethrough and containing an etching solution to etch the target in the space, in which a slope of the etching rail is adjustable with respect to the ground, and the solution supplier provides the etching solution to the etching rail.

The etching rail includes a bottom surface, and a plurality of sidewalls extending from an edge of the bottom surface to form the space.

The etching rail further includes a guide member which supports an end portion of the target so that the target is separated from the bottom surface by a predetermined distance and guides a moving path of the target.

An etching method, according to an embodiment of the present invention, is provided as follows. An etching solution is supplied to an etching rail, a slope of the etching rail is adjusted with respect to the ground and then, the target is input in the etching rail to be etched by the etching solution.

If the slope of the etching rail is adjusted, the etching solution contained in the etching rail is discharged, and the etching solution is supplied to the etching rail such that the etching solution is circulated in the etching rail.

An etching apparatus, according to an embodiment of the present invention, includes a fixing member and a nozzle unit. The fixing member positions a target in a direction vertical to the ground. The nozzle unit includes a solution vessel, which is provided above the target to receive and store an etching solution to etch the target, and a body located adjacent to the target, which is provided with a space to contain the solution vessel and an outlet to discharge the etching solution overflown from the solution vessel to an exterior such that the etching solution is supplied to the target.

The body includes a top surface, sidewalls extending from the top surface to form the space, and a bottom surface which is partially open such that the outlet is formed.

The sidewalls are narrowed downward from the top surface such that the etching solution is discharged to an exterior through the outlet.

An etching method, according to an embodiment of the present invention, is provided as follows. First, a target is positioned in a direction vertical to the ground. The target is arranged below a solution vessel, and then an etching solution is supplied into the solution vessel such that the etching solution is overflown from the solution vessel. Thereafter, the etching solution is provided to an upper end portion of the target by guiding the etching solution overflown from the solution vessel.

According to the etching apparatus and etching method of embodiments of the present invention, pressure exerted on the substrate can be reduced, and an entire surface of the substrate can be uniformly pressed during the etching process. Therefore, since the breakage of the substrate is prevented and the substrate is uniformly etched, the thickness of the substrate can be reduced.

### BRIEF DESCRIPTION OF THE DRAWINGS

Embodiments the present invention can be understood in more detail from the following detailed description when considered in conjunction with the accompanying drawings wherein:

FIG. 1 is a view showing an etching apparatus according to an embodiment of the present invention;

FIG. 2 is a perspective view showing an etching rail of FIG. 1;

FIG. 3 is a sectional view taken along a line I-I′ of FIG. 2;

FIG. 4 is a sectional view taken along a line II-II′ of FIG. 2;

FIGS. 5A to 5C are sectional views showing an etching rail according to an embodiment of the present invention;

FIG. 6 is a flowchart illustrating a method of etching a substrate according to an embodiment of the present invention;

FIG. 7 is a sectional view for illustrating a process of etching a substrate in an etching rail according to an embodiment of the present invention;

FIG. 8 is a view showing an etching apparatus according to an embodiment of the present invention;

FIG. 9 is a perspective view showing a fixing member shown in FIG. 8;

FIG. 10 is a sectional view taken along a line III-III′ of FIG. 9;

FIG. 11 is an enlarged perspective view of a part ‘A’ shown in FIG. 9;

FIG. 12 is an enlarged plan view of a part A shown in FIG. 9;

FIG. 13 is a sectional view taken along a line IV-IV′ of FIG. 9;

FIG. 14 is a sectional view taken along a line V-V′ of FIG. 8;

FIG. 15 is a perspective view showing a body shown in FIG. 14;

FIG. 16 is an enlarged sectional view of a part ‘B’ shown in FIG. 14; and

FIG. 17 is a flowchart illustrating a method of etching a substrate according to an embodiment of the present invention.

### DESCRIPTION OF THE EMBODIMENTS

Hereinafter, embodiments the present invention will be explained in further detail with reference to the accompanying drawings.

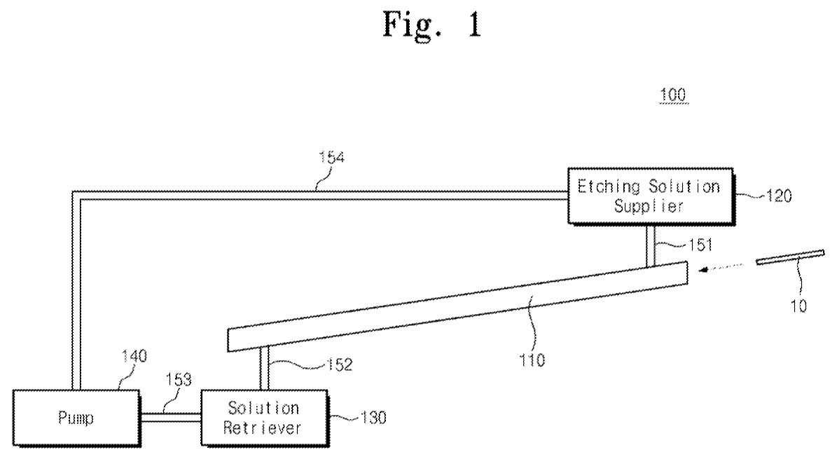

FIG. 1 is a view showing an etching apparatus 100 according to an embodiment of the present invention.

Referring to FIG. 1, the etching apparatus 100 includes an etching rail 110 used to etch a substrate 10, and an etching solution supplier 120 in which etching solution is stored.

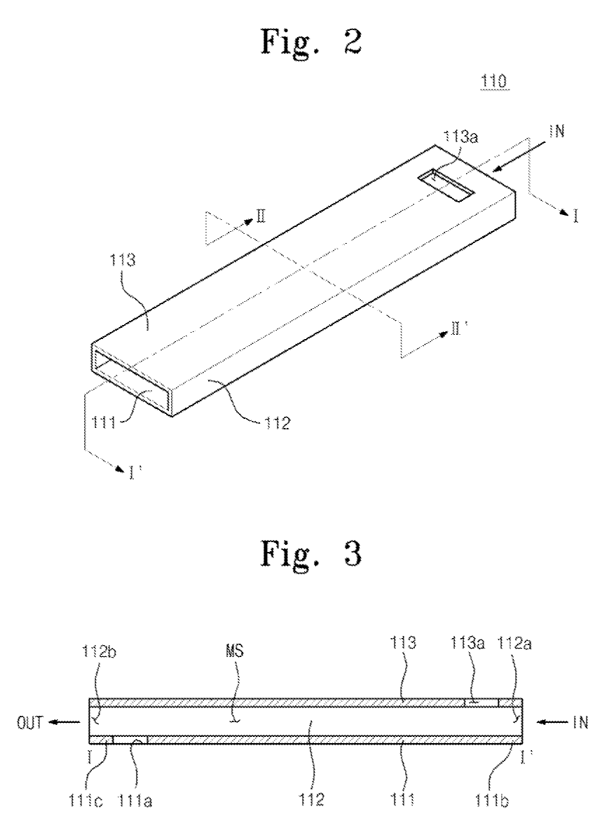

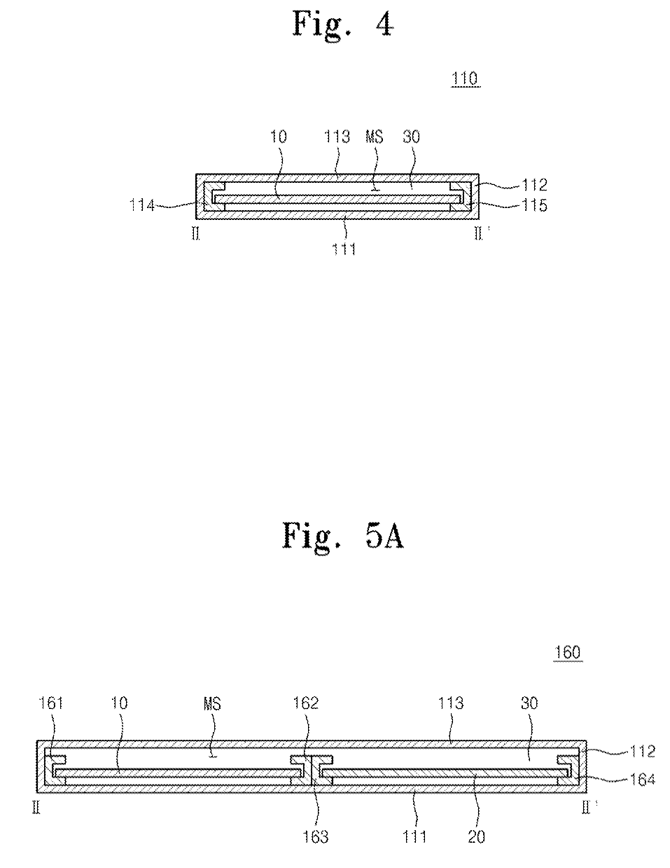

FIG. 2 is a perspective view showing the etching rail 110 of FIG. 1, FIG. 3 is a sectional view taken along a line I-I′ of FIG. 2, and FIG. 4 is a sectional view taken along a line II-II′ of FIG. 2.

Referring to FIGS. 2 and 3, the etching rail 110 has a mobile space MS allowing the movement of the substrate 10, and including an etching solution. For example, the mobile space is filled with an etching solution.

The etching rail 110 includes a bottom surface 111, sidewalls 112 extending from the bottom surface 111 to form the mobile space MS, and a top surface 113 facing the bottom surface 111.

First and second openings 112a and 112b, which are positioned opposite to each other, are formed at both longitudinal end portions of the sidewalls 112. The substrate 10 is introduced into the mobile space through the first opening 112a and then is discharged through the second opening 112b.

According to an embodiment, the etching rail 110 is provided with the first and second openings 112a and 112b in order to open both end portions thereof. However, the etching rail 110 further includes an opening/closing member allowing opening and closing of the first and second openings 112a and 112b to close the mobile space. For example once the substrate 10 is received in the mobile space, the opening/closing member is coupled with the etching rail 110 to close the mobile space. In addition, when the substrate 10 is input/output into/from the etching rail 110, the opening/closing member is separated from the etching rail 110 to open the mobile space.

A portion of the bottom surface 111 is removed such that an outlet 111a is formed to discharge the etching solution, and the outlet 111a is positioned near the second opening 112b.

The top surface 113 is coupled with the sidewalls 112. In addition a portion of the top surface 113 is removed such that an inlet 113a is formed to receive the etching solution. The inlet 113a is positioned near the first opening 112a, and the etching solution is input into the mobile space MS through the inlet 113a.

Referring to FIG. 4, the etching rail 110 further includes a guide member, which guides the substrate 10.

The guide member includes first and second guide members 114 and 115. The first and second guide members 114 and 115 are placed in the mobile space to separate the substrate 10 from the bottom surface 111 by a predetermined distance.

In other words the first guide member 114 supports a first end portion of the substrate 10. The second guide member 115 which is opposite to the first guide member 114 supports a second end portion of the substrate 10.

According to an embodiment, the first and second guide members 114 and 115 have U-shape. However, the first and second guide members 114 and 115 may have, for example an L-shape, or a rod shape.

The first and second guide members 114 and 115 separate the substrate 10 from the bottom surface 111 and the top surface 113 such that the etching solution 30 contained in the mobile space is uniformly provided to the entire surface of the substrate 10. Therefore, the substrate 10 can be etched with a uniform thickness.

Referring to FIGS. 2 and 4, the bottom surface 111 of the etching rail 110 faces the ground, and a slope of the etching rail 110 is adjusted with respect to the ground. More specifically, the slope of the etching rail 110 is adjusted with respect to the ground such that an etching time and an etching thickness of the substrate 10 can be controlled.

In other words, if the etching rail 110 is inclined with respect to the ground, the substrate 10 provided in the mobile space moves down the incline of the etching rail 110. In addition friction occurring between the substrate 10 and the etching solution 30 accelerates an etching rate of the substrate 10.

The etching rail 110 is tilted in the longitudinal direction thereof, and the substrate 10 is moved lengthwise along the etching rail 110 in the mobile space MS. If the substrate 10 is provided parallel to the bottom surface 111 in the etching rail 110. After tilting the etching rail 110, the substrate 10 is moved in a direction parallel to the etching rail 110 in the mobile space MS. Since the etching rail 110 can minimize the pressure exerted on the substrate 10 and uniformly apply pressure onto the substrate 10, breakage of the substrate 10 can be prevented, and the substrate 10 can be uniformly etched.

Referring to FIGS. 1, 3, and 4, the etching solution supplier 120 is equipped above the etching rail 110. The etching solution supplier 120 stores the etching solution to be provided to the etching rail 110.

If the etching rail 110 is tilted in a predetermined direction with respect to the ground, the etching solution 30 contained in the mobile space MS moves together with the substrate 10 down the incline of the etching rail 110. If the etching rail 110 is tilted such that the first end portion 111b including the first opening 112a sits higher than the second end portion 111c including the second opening 112b, the etching solution 30 contained in the etching rail 110 ail moves to the second opening 112b and then is discharged from the etching rail 110 through the outlet 111a.

If the etching solution 30 contained in the etching rail 110 has been discharged the etching rail 110 receives additional etching solution from the etching solution supplier 120 equal to or about equal to an amount of the discharged etching solution. In other words, the etching rail 110 continuously discharges the etching solution, and continuously receives the etching solution from the etching solution supplier 120, so that the mobile station MS is always filled with the etching solution.

The slope of the etching rail 110 is adjusted such that the substrate 10 is uniformly etched as described above, and the etching solution is discharged to the exterior such that sludge derived from the reaction between the substrate 10 and the etching solution is not deposited in the etching rail 110r

The etching apparatus 100 further includes a solution retriever 130, which retrieves the etching solution discharged from the etching rail 110, a pump 140, which provides the etching solution contained in the solution retriever 130 to the etching solution supplier 120, and first, second, third and fourth connection tubes 151, 152, 153, and 154.

The solution retriever 130 stores the etching solution discharged from the etching rail 110.

The pump 140 provides the etching solution contained in the solution retriever 130 to the solution supplier 120.

The first to fourth connection tubes 151, 152, 153, and 154 provide a mobile path for the etching solution.

The first connection tube 151 connects the etching rail 110 to the solution supplier 120 to provide the etching solution discharged from the etching solution supplier 120 to the etching rail 110. The first connection tube 151 has one end portion inserted into the inlet 113a (see, FIG. 2) formed in the etching rail 110.

The second connection tube 152 connects the etching rail 110 to the etching solution retriever 130 to provide the etching solution discharged from the etching rail 110 to the etching solution retriever 130.

The third connection tube 153 connects the solution retriever 130 to the pump 140 to provide the etching solution discharged from the solution retriever 130 to the pump 140.

The fourth connection tube 154 connects the solution supplier 120 to the pump 140 to provide the etching solution discharged from the pump 140 to the solution supplier 120.

As described above, the first to fourth connection tubes 151 to 154 connect the etching rail 110 to the solution supplier 120, the solution retriever 130, and the pump 140 to provide paths of supplying and retrieving the etching solution.

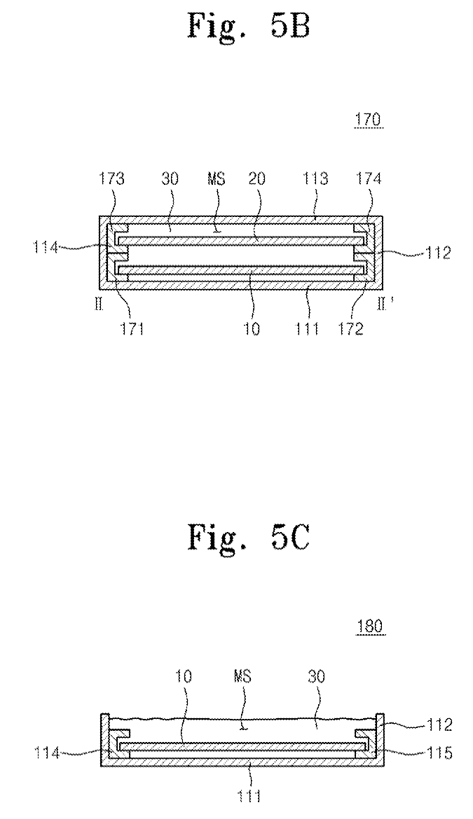

FIGS. 5A to 5C are sectional views showing an etching rail according to an embodiment of the present invention.

An etching rail 160 shown in FIG. 5A has the same components as those of the etching rail 110 shown in FIG. 4 with some exceptions. Referring to FIG. 5A, the etching rail 160 includes a bottom surface 111, sidewalls 112, a top surface 113, a guide member, and a mobile space MS allowing the movement of substrates 10 and 20. The mobile space has a size large enough to receive multiple substrates 10 and 20.

The number of the substrates received by the mobile space may increase according to the size of the mobile space MS.

The guide member includes first, second, third and fourth guide members 161, 162, 163 and 164.

According to the present embodiment although the etching rail 160 includes four guide members 161 to 164, the number of the guide members may be reduced or increased according to the size of the mobile space MS and/or the size of the substrates 10 and 20.

The first to fourth guide members 161 to 164 are sequentially arranged in a direction along a width of the etching rail 160. The first and second guide members 161 and 162 face each other and support both end portions of the first substrate 10. The third and fourth guide members 163 and 164 face each other and support both end portions of the second substrate 20.

An etching rail 170 shown in FIG. 5B has the same components as those the etching rail 110 shown in FIG. 4 with some exceptions. Referring to FIG. 5B, the etching rail 170 includes a bottom surface 111, sidewalls 112, a top surface 113, a guide member and a mobile space MS allowing the movement of substrates 10 and 20. The mobile space has a size large enough to receive multiple substrates 10 and 20 therein.

The number of the substrates may be increased according to the size of the mobile space MS.

The guide member includes first, second, third and fourth guide members 171, 172, 173 and 174.

Although the etching rail 170 includes four guide members 171 to 174 the number of the guide members may be reduced or increased according to the size of the mobile space MS and/or the size of the substrates 10 and 20.

The first and second guide members 171 and 172 face each other and support both end portions of the first substrate 10. The third guide member 173 is located above the first guide member 171, and the fourth guide member 174 is positioned above the second guide member 172. The third and fourth guide members 173 and 174 face each other and support both end portions of the second substrate 20. Accordingly, the second substrate 20 is arranged above the first substrate 10.

An etching rail 180 shown in FIG. 5C has the same components as those of the etching rail 110 shown in FIG. 4 with some exceptions.

Referring to FIG. 5C, the etching rail 180 includes a bottom surface 111, sidewalls 112 extending from an edge of the bottom surface 111 to form a mobile space MS allowing the movement of the substrate 10, and first and second guide members 114 and 115.

The top surface of the etching rail 180 is open, and the substrate 10 is input/output to/from the mobile space MS through the open top surface. The first and second guide members 114 and 115 guide the substrate 10 to prevent the substrate 10 from being separated from the etching rail 180.

The etching rail 180 includes two guide members 114 and 115, but the number of the guide members 114 and 115 may be increased according to the size of the mobile space MS and the size of the substrate 10.

Hereinafter, a process of etching the substrate 10 by using the etching rail 110 will be described in further detail.

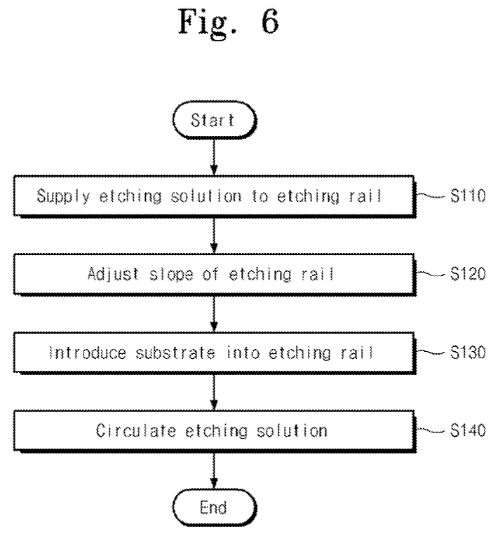

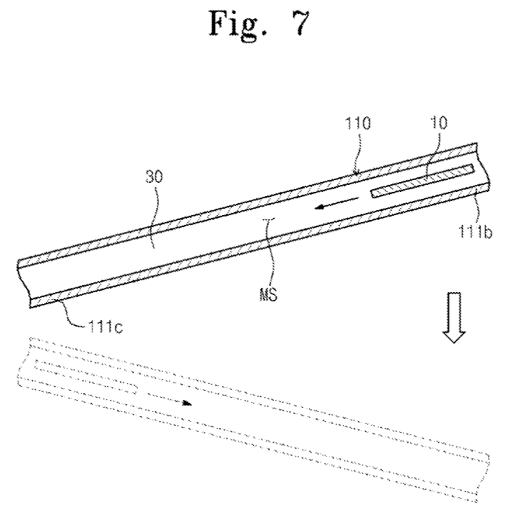

FIG. 6 is a flowchart illustrating a method of etching the substrate according to an embodiment of the present invention, and FIG. 7 is a sectional view for illustrating a process of etching the substrate in the etching rail shown in FIG. 1.

Referring to FIGS. 1, 6, and 7, the etching solution supplier 120 supplies the etching solution to the etching rail 110 through the first connection tube 151, and the mobile space of the etching rail 110 receives the etching solution 30 (step S110).

The slope of the etching rail 110 is adjusted with respect to the ground such that the etching rail 110 is tilted at a predetermined angle with respect to the ground (step S120). The etching apparatus 100 can control the slope of the etching rail 110 to determine the etching thickness of the substrate 10.

The substrate 10 is input into the mobile space of the etching rail 110, and then moves along the tilting direction of the etching rail 110 (step S130).

Since the substrate 10 is etched while moving in a direction parallel to the etching rail 110 in the mobile space as described above, the substrate 10 is uniformly etched. In addition, since the pressure exerted on the substrate 10 can be minimized during the etching process, the breakage of the substrate 10 can be prevented, and the thickness of the substrate 10 can be reduced.

If the etching rail 110 is tilted by a predetermined angle with respect to the ground, the etching solution 30 contained in the mobile space MS is circulated along the tilting direction of the etching rail 110 (step S140).

In other words, the etching solution 30 contained in the mobile space MS moves along the tilting direction of the etching rail 110. If the second end portion 111c (see, FIG. 3) of the etching rail 110 is positioned lower than the first end portion 111b, the etching solution 30 contained in the mobile space MS is discharged to the exterior through the outlet 111a. The etching rail 110 receives the etching solution from the etching solution supplier 120 while discharging the etching solution. The discharged etching solution 30 is supplied to the solution retriever 130 through the second connection tube 152, and the etching solution 30 stored in the solution retriever 130 is provided to the pump 140 through the third connection tube 153. The pump 140 supplies the etching solution to the etching solution supplier 120 through the fourth connection tube 154.

According to an embodiment the etching rail 110 continuously discharges the etching solution, and continuously receives the etching solution from the etching solution supplier 120 while etching the substrate 10.

Alternatively, the etching rail 110 does not discharge or receive etching solution continuously while etching the substrate 10. Referring to FIG. 7, if the substrate 10 is input, the mobile space MS of the etching rail 110 is closed in order to prevent exiting of the substrate 10 from the etching rail 110. The closed etching rail 110 is tilted such that the first end portion 111b of the bottom surface 111 moves down, and then tilted inversely such that the second end portion 111c of the bottom surface 111 moves down. The etching rail 110 is used to etch the substrate 10 by repeating the tilting procedures. The number of tilting operations for the etching rail 110 is determined depending on the etching amount of the substrate 10.

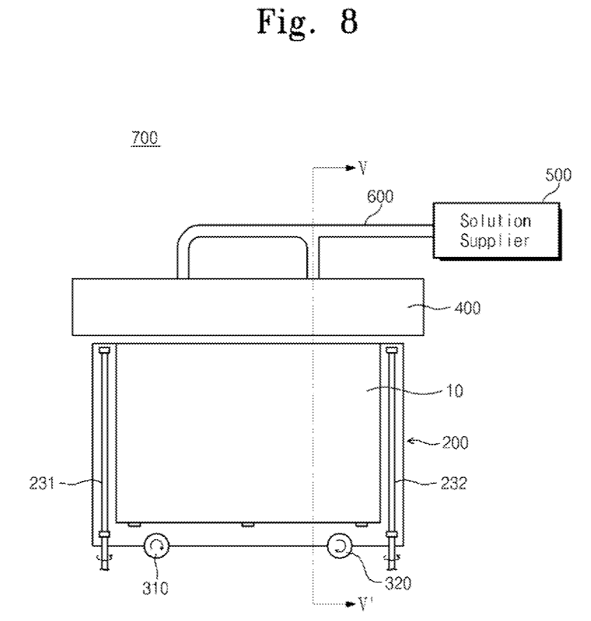

FIG. 8 is a view showing an etching apparatus 700 according to an embodiment of the present invention.

Referring to FIG. 8, the etching apparatus 700 includes a fixing member 200 which holds a substrate 10, transport rollers 310 and 320 which transport the fixing member 200, a nozzle unit 400 which provides etching solution to the substrate 10, a solution supplier 500 which stores the etching solution, and a pipe unit 600 used to move the etching solution.

The fixing member 200 receives the substrate 10, whereby the substrate 10 is positioned in the fixing member 200 perpendicular to (vertical to) the ground.

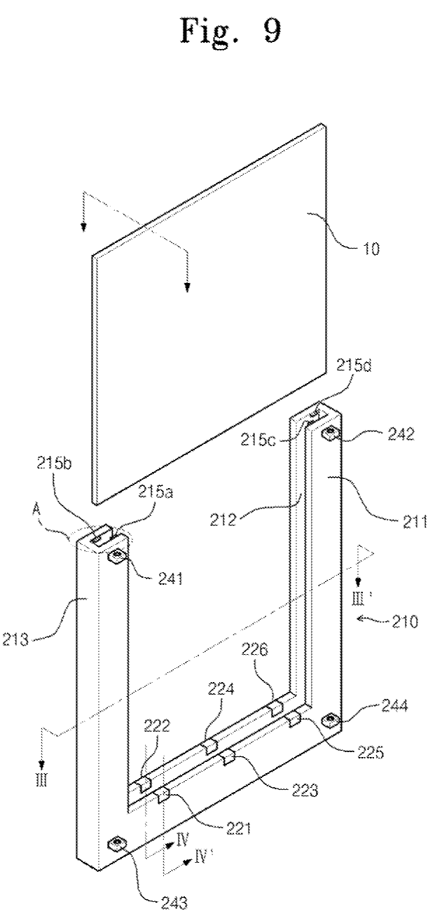

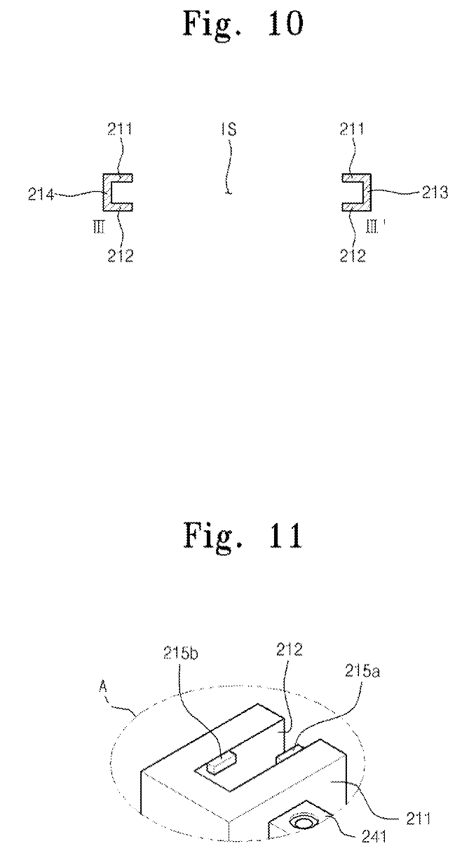

FIG. 9 is a perspective view illustrating the fixing member 200 of FIG. 8 and FIG. 10 is a sectional view taken along a line III-III′ of FIG. 9.

Referring to FIGS. 9 and 10, the fixing member 200 includes a receiver 210 which receives the substrate 10, a plurality of supporters 221-226 which fix the substrate 10 to the receiver 210, first and second pick-up rollers 231 and 232 which position the receiver 210 in the direction perpendicular to the ground, and a plurality of insertion parts 241-244 coupled with the first and second pick-up rollers 231 and 232.

The receiver 210 has an insertion space which receives the substrate 10 therein. In detail, the receiver 210 includes a first frame 211, a second frame 212 facing the first frame 211 and first and second side plates 213 and 214 connected to the first and second frames 211 and 212.

The center portion of the first and second frames 211 and 212 is removed to form a U-shape, thereby reducing the weight of the receiver 210. Alternatively, the center portion of the first and second frames 211 and 212 may be not removed.

The first side plate 213 is connected to the second frame 212 while extending from an end portion of the first frame 211. The second side plate 214 faces the first side plate 213. In addition, the second side plate 214 is connected to the second frame 212 while extending from an end portion of the first frame 211.

The insertion space IS is defined by the first and second frames 211 and 212 and the first and second side plates 213 and 214. If the substrate 10 is inserted into the insertion space IS, the first and second frames 211 and 212 face the substrate 10.

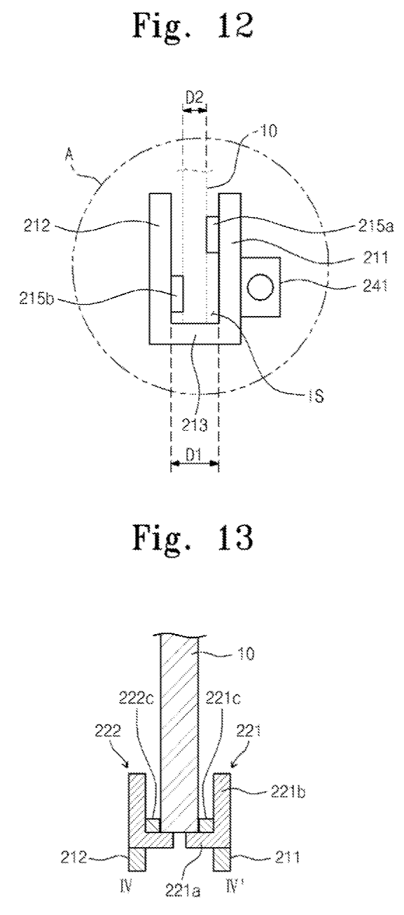

FIG. 11 is an enlarged perspective view of a part ‘A’ shown in FIG. 9, and FIG. 12 is an enlarged plan view of the part ‘A’ shown in FIG. 9.

Referring to FIGS. 9, 11, and 12, a width D1 between the first and second frames 211 and 212 is wider than a thickness D2 of the substrate 10. Accordingly, the receiver 210 can ensure a sufficient space allowing the etching solution provided through the nozzle unit 400 to flow along the surface of the substrate 10.

Since the width D1 between the first and second frames 211 and 212 is wider than the thickness D2 of the substrate 10 as described above, the substrate 10 may be shifted within the insertion space IS. If the substrate 10 is shifted, one of the first and second frames 211 and 212 makes contact with the substrate 10. Accordingly, the etching solution may not uniformly flow along the surface of the substrate 10.

In order to prevent the etching solution from irregularly flowing, the receiver 210 further includes first, second, third and fourth separators 215a, 215b, 215c and 215d.

The number of the separators may be reduced or increased according to the size of the receiver 210.

The first to fourth separators 215a to 215d support the upper portion of the substrate 10. The first and third separators 215a and 215c protrude from the first frame 211 in the insertion space IS. The second and fourth separators 215b and 215d protrude from the second frame 212 in the insertion space IS.

The first separator 215a is positioned near the second separator 215b and opposite the third separator 215c with respect to the insertion space IS.

Although the first separator 215a is positioned offset from the second separator 215b, alternatively, the first separator 215a may face the second separator 215b.

The first separator 215a separates the substrate 10 from the first frame 211 by a predetermined distance to prevent the substrate 10 from making contact with the first frame 211.

The second separator 215b separates the substrate 10 from the second frame 212 by a predetermined distance to prevent the substrate 10 from making contact with the second frame 212.

The arrangement relationship between the third and fourth separators 215c and 215d and functions thereof are similar to the arrangement and function of the first and second separators 215a and 215b.

As described above, the first to fourth separators 215a to 215d separate the substrate 10 from the first and second frames 211 and 212. Accordingly, since the etching solution supplied to the substrate 10 uniformly flows along the surface of the substrate 10, the substrate 10 is uniformly etched.

Referring again to FIG. 9, since the lower surface of the receiver 210 is open, the substrate 10 may be separated from the receiver 210. A plurality of supporters 221-226 are coupled with the receiver 210 to support the substrate 10 in the receiver 210.

The plurality of supporters include first, second, third, fourth, fifth and sixth supporters 221, 222, 223, 224, 225 and 226 in order to support the side portions of the substrate 10.

The number of the supporters may be increased or reduced according to the size of the substrate 10.

The first third, and fifth supporters 221, 223, and 225 are coupled with the first frame 211 and separated from each other by a predetermined interval. The second, fourth, and sixth supporters 222, 224, and 226 are coupled with the second frame 212 and separated from each other by a predetermined interval.

The first, third, and fifth supporters 221, 223, and 225 face the second, fourth, and sixth supporters 222, 224, and 226, respectively.

Since the first to sixth supporters 221 to 226 according to the present embodiment have the same structure, the first supporter 221 will be described in detail below as an example.

FIG. 13 is a sectional view taken along a line IV-IV′ of FIG. 9.

Referring to FIGS. 9 and 13, the first supporter 221 includes a first plate 221a which supports a side portion of the substrate 10 and a second plate 221b which faces the substrate 10 while extending from an end portion of the first plate 221a. The first plate 221a is positioned in the insertion space IS (see, FIG. 10), and the second plate 221b is separated from the substrate 10 by a predetermined distance.

In addition, the first supporter 221 further includes a protrusion 221c from the first plate 221a. The protrusion 221c separates the substrate 10 from the second plate 221b in order to maintain the distance between the substrate 10 and the first frame 211.

The second supporter 222 faces the first supporter 221. A protrusion 222c formed at the second supporter 222 maintains a distance between substrate 10 and the second frame 212.

Referring to FIGS. 8 and 9, the first and second pick-up rollers 231 and 232 have a shape of a cylinder and extend in a direction perpendicular to the ground. The first and second pick-up rollers 231 and 232 face each other and rotate to move the receiver 210.

The number of the pick-up rollers 231 and 232 may be increased or reduced according to the size of the fixing member 200.

The first and second pick-up rollers 231 and 232 are inserted into a plurality of insertion parts and coupled with the receiver 210. The insertion parts include first, second, third and fourth insertion parts 241, 242, 243 and 244.

The number of the insertion parts may be increased or reduced depending on the size of the receiver 210 and the number of the pick-up rollers.

The first to fourth insertion parts 241 to 244 are coupled with the first frame 211 and positioned at corners of the first frame 211, respectively.

The first and third insertion parts 241 and 243 are provided with insertion holes allowing the insertion of the first pick-up roller 231, and the first pick-up roller 231 is inserted into the first and third insertion parts 241 and 243 to hold the receiver 210.

The second and fourth insertion parts 242 and 244 are provided with insertion holes allowing the insertion of the second pick-up roller 232, and the second pick-up roller 232 is inserted into the second and fourth insertion parts 242 and 244 to hold the receiver 210.

Since the receiver 210 is held perpendicular to the ground by the first and second pick-up rollers 231 and 232 as described above, the substrate 10 received in the receiver 210 is arranged in the direction perpendicular to the ground.

The fixing member 200 is mounted on upper portions of the first and second transport rollers 310 and 320, and the first and second transport rollers 310 and 320 rotate in a predetermined direction to convey the fixing member 200.

The nozzle unit 400 is provided at the upper portion of the fixing member 200. The nozzle unit 400 supplies the substrate 10 with the etching solution to etch the substrate 10.

Hereinafter, a structure of the nozzle unit 400 will be described in detail with reference to accompanying drawings.

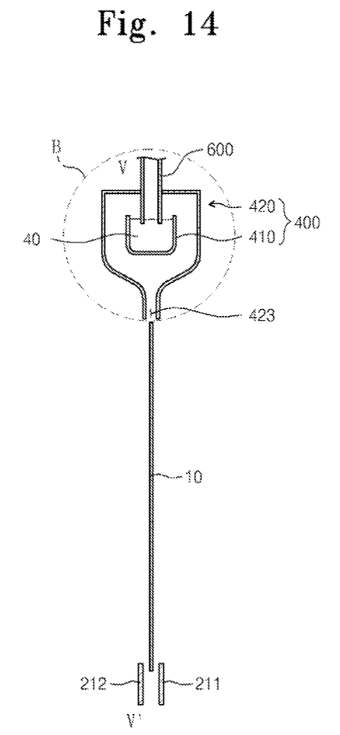

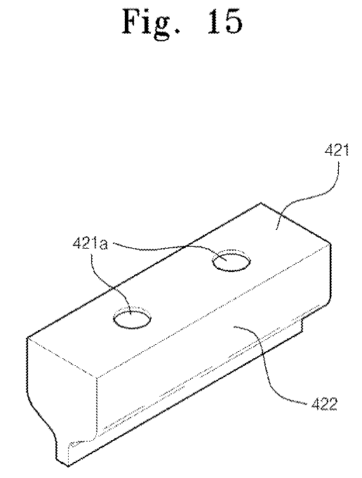

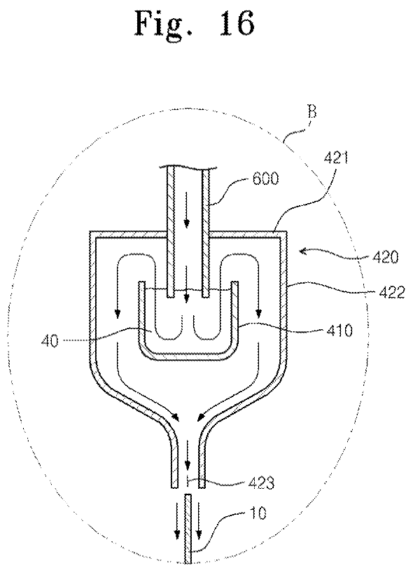

FIG. 14 is a sectional view taken along a line V-V′ of FIG. 8, FIG. 15 is a perspective view showing a body of FIG. 14 and FIG. 16 is an enlarged sectional view of a part ‘B’ shown in FIG. 14.

Referring to FIGS. 14 to 16, the nozzle unit 400 includes a solution vessel 410 containing the etching solution, and a body 420 receiving the solution vessel 410.

The solution vessel 410 has an open upper surface to receive the etching solution from the solution supplier 500 (see, FIG. 8) and contains the etching solution therein.

The body 420 has a space to contain the solution vessel 410 and an outlet 423 formed by opening a bottom surface thereof. The outlet 423 discharges the etching solution discharged from the solution vessel 410. The etching solution is excessively supplied from the solution supplier 500 (see, FIG. 8) such that the etching solution contained in the solution vessel 410 overflows. The overflowed etching solution is discharged to an exterior through the outlet 423, and is provided to an upper end portion of the substrate 10.

Referring to FIG. 15 the body 420 includes an upper surface 421 and sidewalls 422 extending from end portions of the upper surface 421 to form the space. Portions of the upper surface 421 are partially removed such that holes 421a are formed. The pipe unit 600 is inserted into the holes 421a such that the etching solution from the solution supplier 500 is provided into the solution container 410.

The lower portion of the sidewalls 422 narrows as compared with the upper surface 421. In other words, the sidewalls 422 are gradually narrowed from the upper surface 421 toward the outlet 423 such that the etching solution overflown from the solution vessel 410 is guided to the outlet 423.

The etching solution discharged through the outlet 423 is accumulated on the upper end portion of the substrate 10 arranged below the nozzle unit 400, and flows to a lower end portion of the substrate 10 along the surface of the substrate 10. In this case, the fixing member 200 is arranged near the nozzle unit 400 in order to minimize the pressure exerted on the substrate 10 from the etching solution dropped through the outlet 423.

As described above, the etching solution etches the substrate 10 while flowing along the surface of the substrate 10. In this case, a lower part of the receiver 210 is open. Accordingly, the etching solution flowing along the substrate 10 is discharged to the outside of the fixing member 200 through the open lower part of the receiver 210.

Hereinafter, a process of etching the substrate 10 using the etching apparatus 700 will be described in detail with reference to accompanying drawings.

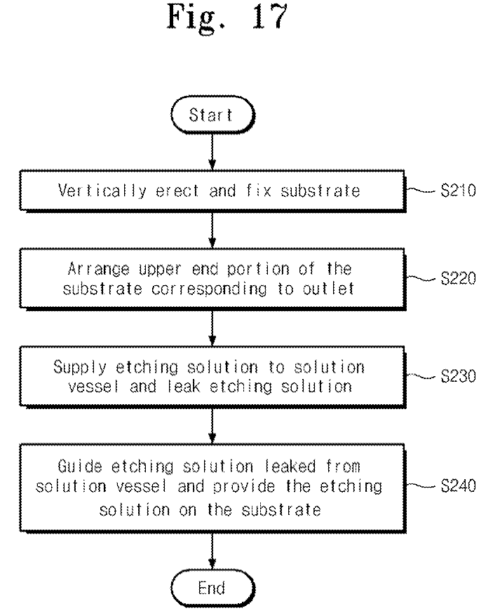

FIG. 17 is a flowchart illustrating a method of etching a substrate according to an embodiment of the present invention.

Referring to FIGS. 8, 16, and 17, after inserting the substrate 10 into the receiver 210 (see, FIG. 9), the first and second pick-up rollers 231 and 232 are inserted into the receiver 210 to position the receiver 210 in the direction perpendicular to the ground (step S210). Therefore, the substrate 10 is arranged in the direction perpendicular (vertical) to the ground.

The first and second transport rollers 310 and 320 rotate, thereby arranging the fixing member 200 below the nozzle unit 400, and then the upper end portion of the substrate 10 is arranged corresponding to the outlet 423 (see, FIG. 14) of the nozzle unit 400 (step S220).

The solution supplier 500 supplies the etching solution to the solution vessel 410 through the pipe unit 600 such that the etching solution 40 contained in the solution vessel 420 overflows (leaks) (step S230).

The overflowed (leaked) etching solution is discharged to the exterior through the outlet 423 along the sidewalls 422 of the body 420. Then, the etching solution discharged from the nozzle unit 400 is supplied to the substrate 10 arranged below the nozzle unit 400 (step S240).

The etching solution dropped on the upper end portion of the substrate 10 etches the substrate 10 while flowing along the surface of the substrate 10.

The etching apparatus 700 is provided with the nozzle unit 400 arranged near the substrate 10, and the etching solution is dropped on the upper end portion of the substrate 10, thereby minimizing the pressure exerted on the substrate 10. Accordingly, the breakage of the substrate 10 can be prevented during the etching process, and the thickness of the substrate 10 can be reduced. In addition, since the nozzle unit 400 uniformly drops the etching solution on the upper end portion of the substrate 10, the etching solution is uniformly coated on the substrate 10. Accordingly, the substrate 10 can be uniformly etched.

The etching apparatus moves the substrate along the etching rail containing the etching solution in parallel to the etching rail, thereby etching the substrate. Accordingly, the pressure exerted on the substrate can be minimized, and the entire surface of the substrate can be uniformly pressed during the etching process. Therefore, since the breakage of the substrate is prevented and the substrate is uniformly etched, the thickness of the substrate can be reduced.

In addition, the etching apparatus excessively supplies the etching solution to a nozzle unit arranged near the substrate to accumulate the etching solution on an upper end portion of the substrate. Accordingly, the pressure exerted on the substrate can be minimized and the substrate can be uniformly pressed. Accordingly, the breakage of the substrate is prevented, and the substrate is uniformly etched, such that the thickness of the substrate can be reduced.

Although exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. An etching apparatus comprising:
an etching rail having a space through which at least one target moves and, wherein the space contains an etching solution to etch the target in the space, and a slope of the etching rail with respect to the ground is adjustable and
a solution supplier which provides the etching solution to the etching rail.

2. The etching apparatus of claim 1, wherein the etching rail comprises:
a bottom surface; and
a plurality of sidewalls extending from the bottom surface.

3. The etching apparatus of claim 2, wherein the etching rail further comprises a guide member which supports an end portion of the target and all separates the target from the bottom surface by a predetermined distance.

4. The etching apparatus of claim 3 wherein the guide member comprises:
a first guide member which supports a first end portion of the target and
a second guide member which supports a second end portion of the target and faces the first end portion.

5. The etching apparatus of claim 3 wherein the space contains a plurality of targets and the targets are arranged in the space in a direction perpendicular to a length direction of the etching rail.

6. The etching apparatus of claim 5, wherein the targets comprise first and second targets and
the guide member comprises;
first and second guide members facing each other and supporting two end portions of the first target, respectively; and
third and fourth guide members facing each other and supporting two end portions of the second target, respectively.

7. The etching apparatus of claim 2, wherein the etching rail further comprises a top surface facing the bottom surface.

8. The etching apparatus of claim 1, further comprising:
a solution retriever containing the etching solution discharged from the etching rail; and
a pump providing the etching solution from the solution retriever to the solution supplier.

9. The etching apparatus of claim 1 wherein a direction to which the target moves is substantially parallel to the slope of the etching rail in the space.

10. An etching method comprising:
supplying an etching solution in an etching rail;
adjusting a slope of the etching rail with respect to the ground;
inputting a target into the etching rail; and
etching the target using the etching solution.

11. The etching method of claim 10, after adjusting the slope of the etching rail, further comprising continuously discharging the etching solution from the etching rail and supplying the etching solution to the etching rail to circulate the etching solution in the etching rail.

12. An etching apparatus comprising;
a fixing member which positions a target in a direction perpendicular to the ground; and
a nozzle unit receiving and storing an etching solution, wherein the nozzle unit is provided above the target, and includes a solution vessel, and a body, the body including a space to contain the solution vessel and an outlet to discharge the etching solution overflowed from the solution vessel to an exterior such that the etching solution is supplied to the target.

13. The etching apparatus of claim 12, wherein the body comprises:
a top surface;
sidewalls extending from the top surface to form the space; and
a bottom surface which is partially opened to form the outlet.

14. The etching apparatus of claim 13, wherein the sidewalls are narrowed downward from the top surface.

15. The etching apparatus of claim 122 wherein the outlet is positioned corresponding to the target.

16. The etching apparatus of claim 122 wherein the fixing member comprises:
a receiver having a space to receive the target, a top surface having an open portion adjacent the nozzle unit such that the etching solution is supplied to the target through the open portion of the top surface, and a bottom surface having an open portion such that the etching solution is discharged through the open portion of the bottom surface;
at least one supporter which is coupled with the receiver and supports an end portion of the target; and
a pick-up unit which is coupled with the receiver and positions the receiver in the direction perpendicular to the ground.

17. The etching apparatus of claim 16, wherein the receiver comprises:
a first side plate;
a first frame extending from a first end portion of the first side plate;
a second frame separated from the first frame by a predetermined distance and extending from a second end portion of the first side plate to face the first frame; and
a second side plate connected to the first and second frames and facing the first side plate,
wherein the target is positioned between the first frame and the second frame.

18. The etching apparatus of claim 17, wherein the receiver further comprises:
a first separator protruding from the first frame to maintain a distance between the target and the first frame; and
a second separator protruding from the second frame to maintain a distance between the target and the second frame.

19. The etching apparatus of claim 16, wherein the supporter comprises:
a first plate supporting an end part of the target;
a second plate coupled with the receiver and extending from an end portion of the first plate; and
a protrusion protruding from the first plate to maintain distance between the receiver and the target.

20. An etching method comprising:
positioning a target in a direction perpendicular to the ground;
arranging the target below a solution vessel;
supplying an etching solution into the solution vessel to overflow the etching solution from the solution vessel; and
guiding the etching solution overflown from the solution vessel to provide the etching solution to the target.
